(19) United States
(12) Patent Application Publication
(10) Pub. No.: US 2013/0178152 A1
(43) Pub. Date: Jul. 11, 2013

(54) DATA SEND DEVICE AND DATA RECEPTION DEVICE

(71) Applicant: Kabushiki Kaisha Toshiba, Tokyo (JP)

(72) Inventors: Tsukasa Matoba, Kanagawa (JP); Kiyoshi Toshimitsu, Tokyo (JP); Masayuki Kadono, Tokyo (JP); Yoshiyuki Matsubara, Tokyo (JP); Kenichi Koga, Tokyo (JP); Chisae Suzuki, (US)

(73) Assignee: Kabushiki Kaisha Toshiba, Tokyo (JP)

(21) Appl. No.: 13/621,464

(22) Filed: Sep. 17, 2012

(30) Foreign Application Priority Data
Jan. 10, 2012 (JP) 2012-002164

(51) Int. Cl. H04B 7/24

(52) U.S. Cl. 455/39

(57) ABSTRACT

According to one embodiment, a data send device and a data reception device includes a data send device includes a display unit configured to display a communication state with a data reception device. It further includes a VIDEO control unit configured to control data send to the data reception device. It further includes a wireless control unit configured to display an indication that it is searching the data reception device before making wireless connection with the data reception device, and to display a different indication of connection completion from the indication of the searching state when making wireless connection with the data reception device.

### CROSS-REFERENCE TO RELATED APPLICATIONS

This application is based upon and claims the benefit of priority from Japanese Patent Application No. 2012-002164, filed on Jan. 10, 2012; the entire contents of which are incorporated herein by reference.

### FIELD

Embodiments described herein relate generally to a data send device and a data reception device.

### BACKGROUND

Conventionally, data is sent/received between portable information terminals by use of infrared rays or the like. In recent years, there is a method in which a terminal such as a digital camera having no Internet connection function or call function is approached to the party's terminal to send/receive data between the terminals by use of near wireless communication.

### BRIEF DESCRIPTION OF THE DRAWINGS

FIG. 1 is a diagram illustrating an exemplary structure of hardware of a data send/reception device;

FIG. 2 is a diagram illustrating an exemplary structure of function blocks of the data send/reception device;

FIG. 3 is a flowchart illustrating data send/reception processing; and

FIGS. 4A to 4H are diagrams illustrating display contents of the data send/reception devices in each stage of the data send/reception processing.

### DETAILED DESCRIPTION

In general, according to one embodiment, a data send device and a data reception device includes according to an embodiment, a data send device includes a display unit that displays a communication state with a data reception device as a data send destination. It further includes a VIDEO control unit that controls data send to the data reception device. It further includes a wireless control unit that controls wireless communication with the data reception device, displays, on the display unit, that it is searching the data reception device before making wireless connection to the data reception device, and displays, on the display unit, a different indication of connection completion from the indication of the searching state when making wireless connection to the data reception device.

Exemplary embodiments of a data send device and a data reception device will be explained below in detail with reference to the accompanying drawings. The present invention is not limited to the following embodiments.

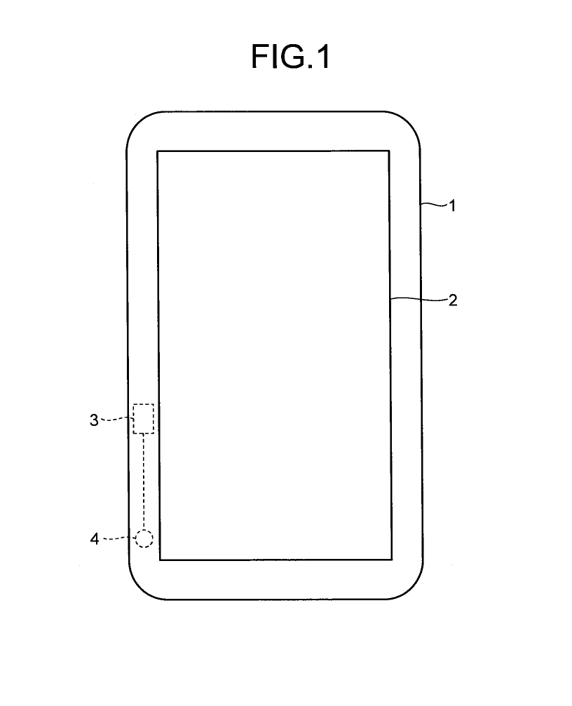

FIG. 1 is a diagram illustrating an exemplary structure of hardware of a data send/reception device. The data send/reception device 1 includes a touch panel unit 2 that displays images and receives touch operations. It further includes a transfer-jet unit 3 and a coupler 4 therein in order to send/receive data to/from other data send/reception device 1. With the transfer-jet unit 3 and the coupler 4, the couplers 4 are made closer to each other in the devices with the same structure (the transfer-jet unit 3 and the coupler 4) to make wireless connection, thereby easily sending/receiving data. The structure is exemplary, and a structure in which a display unit and an operation unit are separated may be used without using the touch panel unit 2. The data send/reception method may employ a method other than transfer-jet.

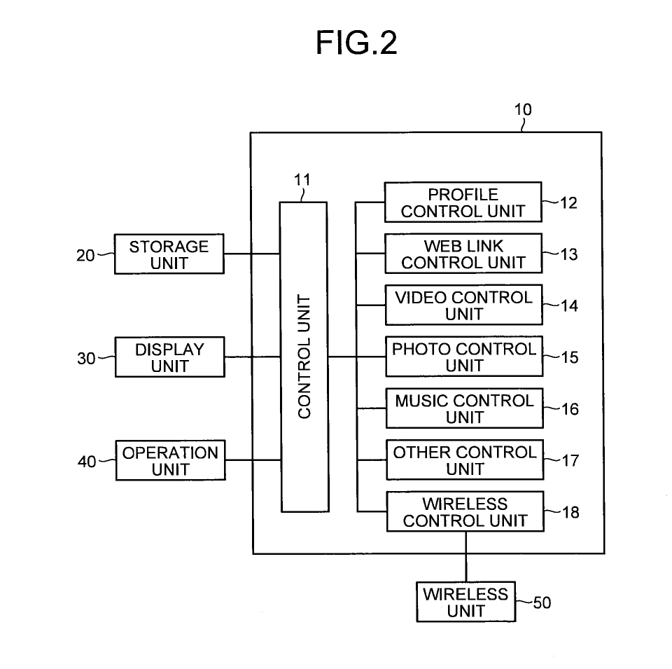

FIG. 2 is a diagram illustrating an exemplary structure of function blocks in the data send/reception device 1. The data send/reception device 1 includes a CPU (Central Processing Unit) unit 10, a storage unit 20, a display unit 30, an operation unit 40 and a wireless unit 50. The CPU unit 10 includes a control unit 11, a PROFILE control unit 12, a WEBLINK control unit 13, a VIDEO control unit 14, a PHOTO control unit 15, a MUSIC control unit 16, an OTHER control unit 17, and a wireless control unit 18.

The control unit 11 controls send/reception of data in all the data types in association with other structure. The PROFILE control unit 12 controls data send/reception processing when the data type is PROFILE. The WEBLINK control unit 13 controls data send/reception processing when the data type is WEBLINK. The VIDEO control unit 14 controls data send/reception processing when the data type is VIDEO (animation). The PHOTO control unit 15 controls data send/reception processing when the data type is PHOTO (still image). The MUSIC control unit 16 controls data send/reception processing when the data type is MUSIC (music). The OTHER control unit 17 controls data send/reception processing when the data type is PDF other than the above data, for example. The wireless control unit 18 performs connection processing or authentication processing with the data send/reception party via the wireless unit 50. Each of the PROFILE control unit 12 to the OTHER control unit 17 is a data control unit that controls the data send/reception processing. Each data control unit is exemplary, and the data send/reception device 1 is assumed to be provided with a corresponding data control unit depending on a type of data to be handled.

The storage unit 20 stores each of the above data such as VIDEO file data described later. The storage unit 20 may be SSD (Solid State Drive), but is not limited thereto.

The display unit 30 displays the standby screen or data thumbnails before performing data send/reception. It corresponds to the touch panel unit 2 in FIG. 1.

The operation unit 40 receives selection of data to be sent from a user. It corresponds to the touch panel unit 2 in FIG. 1.

The wireless unit 50 actually sends/receives data to/from a device as a communication party under control of the wireless control unit 18. It corresponds to the transfer-jet unit 3 and the coupler 4 in FIG. 1.

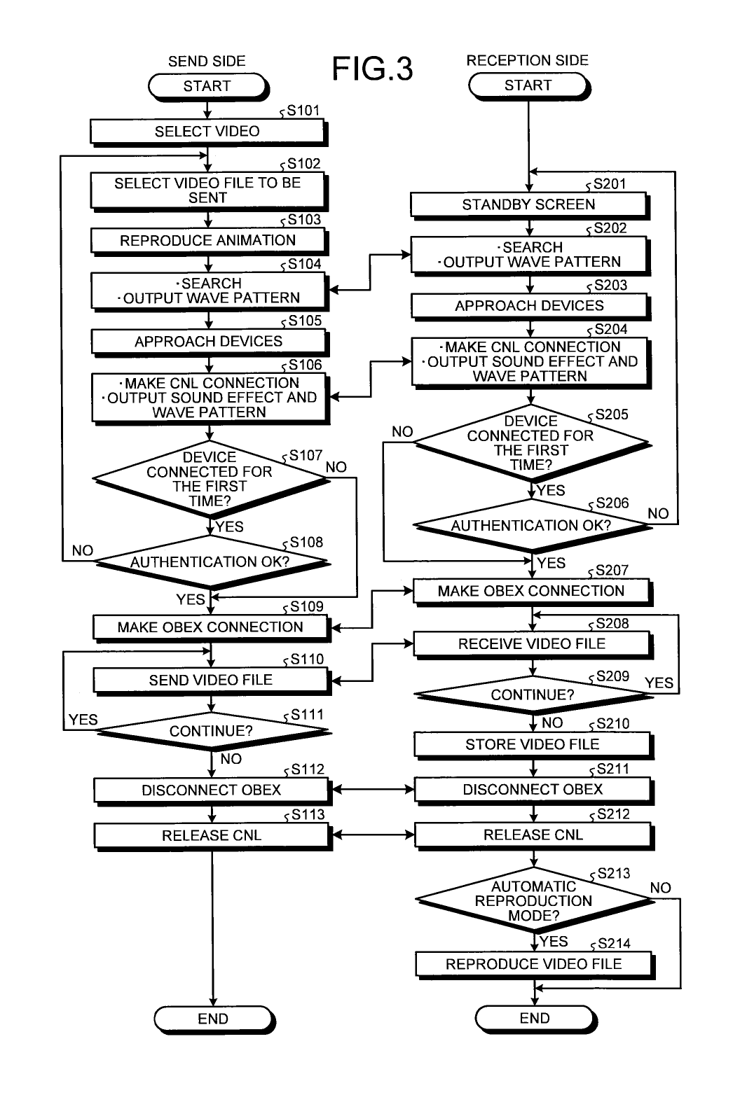

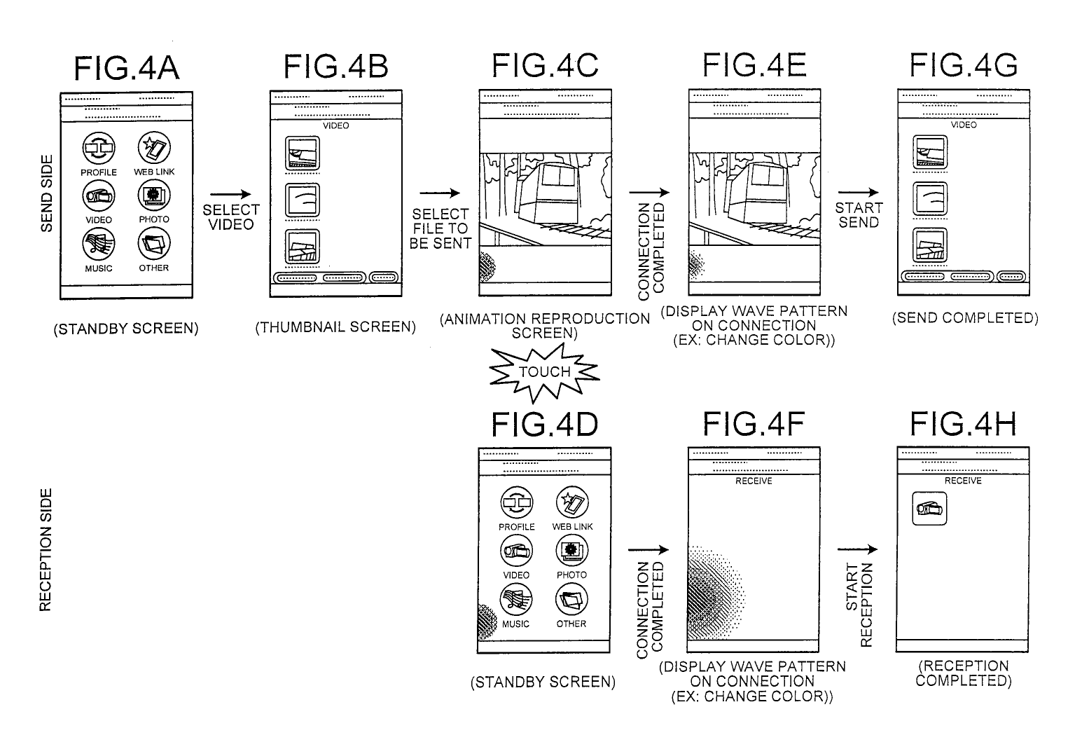

Subsequently, the data send/reception processing performed by the data send/reception device 1 will be described. There will be described herein a case in which two data send/reception devices 1 are used where one is on the send side and the other is on the reception side. FIG. 3 is a flowchart illustrating the data send/reception processing. FIGS. 4A to 4H are diagrams illustrating the display contents of the data send/reception devices in each stage of the data send/reception processing.

At first, the control unit 11 in the data send/reception device 1 on the send side controls the display unit 30 to display the standby screen indicating a data type (FIG. 4A). The data type indicated on the standby screen corresponds to each data control unit in the CPU unit 10. The user selects a data type for send on the standby screen. VIDEO is selected here by way of example (step S101).

The control unit 11 receives the user operations from the operation unit 40, and activates the VIDEO control unit 14. The VIDEO control unit 14 extracts a VIDEO file from the storage unit 20 via the control unit 11 to create thumbnails, and displays the thumbnail screen on the display unit 30 via the control unit 11 (FIG. 4B). The user selects a VIDEO file which he/she wants to send on the thumbnail screen (step S102).

The VIDEO control unit 14 receives the user operations from the operation unit 40 via the control unit 11, and reproduces the selected VIDEO file on the display unit 30 via the control unit 11 (step S103).

While reproducing the VIDEO file, the wireless control unit 18 in the data send/reception device 1 on the send side uses the wireless unit 50 to deliver radios, and searches whether the device that delivers radios or the data reception device as a data send destination (the data send/reception device 1 on the reception side herein) is present in a close range (step S104). At this time, the wireless control unit 18 displays an orange-color wave pattern indicating the search state on the display unit 30 (FIG. 4C). The wave pattern is centered on the position of the coupler 4 illustrated in FIG. 1. The color of the wave pattern is exemplary and other colors may be used.

On the other hand, in the data send/reception device 1 on the reception side, a search is similarly made as to whether the device that delivers radios or the data send device as a data send source (the data send/reception device 1 on the send side herein) is present in a close range (step S202) from the state of the standby screen (FIG. 4D) (step S201). At this time, similar to the data send/reception device 1 on the send side, the wireless control unit 18 displays the orange-color wave pattern indicating the search state on the display unit 30 via the control unit 11.

Then, the data send/reception devices 1 on the send side and on the reception side are approached each other (step S105, S203). In transfer-jet, the approach is called touch (FIGS. 4C and D), and specifically, both the couplers 4 illustrated in FIG. 1 are approached.

The wireless control unit 18 in the data send/reception device 1 on the send side sends a CNL (Connection Layer) connection request from the wireless unit 50 to the data send/reception device 1 on the reception side. The wireless control unit 18 in the data send/reception device 1 on the reception side having received the CNL connection request sends CNLaccept from the wireless unit 50 to the data send/reception device 1 on the send side. Then, the data send/reception device 1 on the send side receives CNLaccept. With the processing, the data send/reception devices 1 on the send side and on the reception side complete the CNL connection (steps S106, S204).

At this time, in the data send/reception devices 1 on the send side and on the reception side, the wireless control unit 18 outputs sound effect indicating the connection completion to the user, and displays a white-color wave pattern indicating the connection completion on the display unit 30 via the control unit 11 (FIGS. 4E, F). Thereby, the user can easily recognize the completed wireless connection. The color of the wave pattern is exemplary and other colors may be used.

When displaying the orange-color wave pattern indicating the search state and the white-color wave pattern indicating the connection completion on the display unit 30, the wireless control unit 18 assumes the position of the coupler 4 illustrated in FIG. 1 as the center of the wave pattern. Thereby, the user can grasp a part where the party's device (the data send/reception device 1) is approached.

Then, in the data send/reception devices 1 on the send side and on the reception side, the VIDEO control unit 14 confirms whether the party device is connected for the first time (steps S107, S205). In the case of the first time (steps S107: Yes, S205: Yes), the VIDEO control unit 14 makes authentication confirmation (steps S108, S206). Specifically, in the data send/reception devices 1 on the send side and on the reception side, the VIDEO control unit 14 displays a pop-up of the authentication confirmation on the display unit 30 via the control unit 11, and receives a user determination via the operation unit 40 and the control unit 11. Thereby, it is possible to prevent data from being sent to an unexpected party.

When the authentication confirmation is OK (steps S108: Yes, S206: Yes), in the data send/reception devices 1 on the send side and on the reception side, the wireless control unit 18 makes OBEX (OBject EXchange) connection (steps S109. S207). Specifically, the wireless control unit 18 in the data send/reception device 1 on the send side sends an OBEX connection request from the wireless unit 50 to the data send/reception device 1 on the reception side. The wireless control unit 18 in the data send/reception device 1 on the reception side having received the OBEX connection request sends OBEXaccept from the wireless unit 50 to the data send/reception device on the send side. Then, the data send/reception device 1 on the send side receives OBEXaccept. With the processing, the data send/reception devices 1 on the send side and on the reception side complete the OBEX connection.

In the data send/reception devices 1 on the send side and on the reception side, the VIDEO control unit 14 skips the steps when the party device is not the first time (steps S107: No, S205: No) and the authentication confirmation (steps S108, S206). The data send/reception device 1 on the send side returns to the thumbnail display screen before selecting the VIDEO file (step S102) when the authentication confirmation is NG (step S108: No), and the data send/reception device 1 on the reception side returns to the standby screen (step S201) when the authentication confirmation is NG (step S206: No).

After the OBEX connection (steps S109, S207), the wireless control unit 18 in the data send/reception device 1 on the send side transfers (PUT) the VIDEO file reproduced in the VIDEO control unit 14 during wireless connection (step S110). Then, when data to be sent is present (step S111: Yes), the wireless control unit 18 continues to transfer (PUT) the VIDEO file via the wireless unit 50 (step S110). The wireless control unit 18 in the data send/reception device 1 on the reception side receives (GET) the VIDEO file via the wireless unit 50 (step S208). Then, when data to be received is present (step S209: Yes), the wireless control unit 18 continues to receive (GET) the VIDEO file via the wireless unit 50 (step S208).

When entering the connection state, the VIDEO control unit 14 in the data send/reception device 1 on the send side stops reproducing the VIDEO file so that loads during the data transfer processing can be reduced in the data send/reception device 1 on the send side. If having a sufficient processing capability, the VIDEO control unit 14 in the data send/reception device 1 on the send side can transfer the data without stopping reproducing the VIDEO file.

In the data send/reception device 1 on the reception side, when the wireless control unit 18 finishes receiving (GET) the VIDEO file via the wireless unit 50 (step S209: No), the VIDEO control unit 14 stores the received VIDEO file in the storage unit 20 via the control unit 11 (step S210).

After the data send/reception device 1 on the send side finishes sending (PUT) the VIDEO file (step S111: No) and after the data send/reception device 1 on the reception side stores the VIDEO file (step S210), in the data send/reception devices 1 on the send side and on the reception side, the wireless control unit 18 disconnects the OBEX connection (steps S112, S211) and releases the CNL connection (steps S113, S212). The screen displays of the data send/reception devices 1 on the send side and on the reception side at this time are as illustrated in FIGS. 4G and H, respectively. The data send/reception device 1 on the send side enters the thumbnail screen before reproducing the VIDEO file and the data send/reception device 1 on the reception side displays an icon of the received VIDEO file thereon.

Then, the data send/reception device 1 on the send side terminates the data send processing. In the data send/reception device 1 on the reception side, when an automatic reproduction mode is set (step S213: Yes), the VIDEO control unit 14 reproduces the received VIDEO file and displays it on the display unit 30 via the control unit 11 (step S214). When the automatic reproduction mode is not set (step S213: No) or after the VIDEO file is reproduced (step S214), the data send/reception device 1 on the reception side terminates the data reception processing.

In this way, the data send/reception devices 1 on the send side and on the reception side display the wave pattern while searching the party device, and changes the color of the wave pattern for display on the completion of wireless connection. Thus, also when sound effect is not set, the setting enables the user to easily recognize that wireless connection is made with the party device.

The case in which the color of the wave pattern is changed on the completion of connection with the party has been described, but the present invention is not limited thereto. For example, when connection with the party is completed, the shape of the wave pattern may be changed. A display method other than wave pattern, such as pop-up, may be used to cause the user to recognize the wireless connection with the party device.

There has been described the case in which the data send/reception device 1 is used both on the send side and on the reception side, but the data send/reception device 1 on the send side may be a data send device dedicated to send and the data send/reception device 1 on the reception side may be a data reception device dedicated to reception. Also in this case, the same processing as the above may be performed and the same effects can be obtained.

As described above, according to the present embodiment, when the wireless control unit 18 in the data send/reception device 1 makes wireless connection to a target device (other data send/reception device 1) for sending or receiving data, the orange-color wave pattern indicating the search state is displayed before wireless connection and the white-color wave pattern with a different color from the search state is displayed when the wireless connection with the target device is completed. Thereby, the users of the data send/reception devices 1 on the send side and on the reception side can easily recognize the completed wireless connection even when sound effect is not set, thereby enhancing user's convenience.

The wireless control unit 18 displays the orange-color wave pattern indicating the search state and the white-color wave pattern indicating the connection completion with the position of the coupler 4 as the center of the wave pattern. Thereby, the user can accurately grasp the part to be approached to the party device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data send device comprising:
a display unit configured to display a communication state with a data reception device as a data send destination;
a data control unit configured to control data send to the data reception device; and
a wireless control unit configured to control wireless communication with the data reception device, to display, on the display unit, that it is searching the data reception device before making wireless connection with the data reception device, and to display, on the display unit, a different indication of connection completion from the indication of the searching state when making wireless connection with the data reception device.

2. The data send device according to claim 1, wherein the wireless control unit displays an indication of the searching state and an indication of the connection completion in a wave pattern and in a different color.

3. The data send device according to claim 1, wherein the wireless control unit displays, on the display unit, an indication of the searching state and an indication after wireless connection in a wave pattern centered on a part to be approached to the data reception device and in a different color.

4. The data send device according to claim 1, wherein the wireless control unit makes wireless communication via transfer-jet.

5. The data send device according to claims 1, wherein the wireless control unit displays an indication of the searching state and an indication after wireless connection in a wave pattern centered on a part to be approached to the data reception device and in a different color, and makes wireless communication via transfer-jet.

6. The data send device according to claim 1, wherein when making wireless connection with the data reception device, the wireless control unit stops reproducing the data.

7. The data send device according to claim 2, wherein when making wireless connection with the data reception device, the wireless control unit stops reproducing the data.

8. The data send device according to claim 3, wherein when making wireless connection with the data reception device, the wireless control unit stops reproducing the data.

9. The data send device according to claim 4, wherein when making wireless connection with the data reception device, the wireless control unit stops reproducing the data.

10. The data send device according to claim 5, wherein when making wireless connection with the data reception device, the wireless control unit stops reproducing the data.

11. A data reception device comprising:
a display unit configured to display a communication state with a data send device as a data send source;
a data control unit configured to control data reception from the data send device; and
a wireless control unit configured to control wireless communication with the data send device, to display, on the display unit, that it is searching the data send device before making wireless connection with the data send device, and to display, on the display unit, a different indication of connection completion from the indication of the searching state when making wireless connection with the data send device.

12. The data reception device according to claim 11, wherein the wireless control unit displays, on the display unit, an indication of the searching state and an indication of the connection completion in a wave pattern and in a different color.

13. The data reception device according to claim 11, wherein the wireless control unit displays, on the display unit, an indication of the searching state and an indication after wireless connection in a wave pattern centered on a part to be approached to the data send device and in a different color.

14. The data reception device according to claim 11, wherein the wireless control unit makes wireless communication via transfer-jet.

15. The data reception device according to claim 11, wherein the wireless control unit displays, on the display unit, an indication of the searching state and an indication after wireless connection in a wave pattern centered on a part to be approached to the data send device and in a different color, and makes wireless communication via transfer-jet.

16. The data reception device according to claim 11, wherein the wireless control unit reproduces the received data.

17. The data reception device according to claim 12, wherein the wireless control unit reproduces the received data.

18. The data reception device according to claim 13, wherein the wireless control unit reproduces the received data.

19. The data reception device according to claim 14, wherein the wireless control unit reproduces the received data.

20. The data reception device according to claim 15, wherein the wireless control unit reproduces the received data.
